(19) United States
(12) Patent Application Publication
(10) Pub. No.: US 2019/0299514 A1
(43) Pub. Date: Oct. 3, 2019

(54) Die for a hollow profile extruder

(71) Applicant: RAUMEDIC AG, Münchberg (DE)

(72) Inventors: Martin Silbermann, Kirchenlamitz (DE); Martin Schenkel, Schnelldorf (DE)

(21) Appl. No.: 16/364,708

(22) Filed: Mar. 26, 2019

(30) Foreign Application Priority Data
Mar. 28, 2018 (DE) 10 2018 204 729.4

(51) Int. Cl. B29C 48/325; B29C 48/25; B29C 48/09

(52) U.S. Cl. CPC B29C 48/327; B29C 48/09; B29C 48/2562

(57) ABSTRACT

An extrusion die is part of a hollow profile extruder. The extrusion die has a die housing. An extrusion annulus is inwardly defined by a mandrel and outwardly defined by a die ring. The mandrel is held and supported by a housing-side mandrel support. The mandrel support is mounted by a tilt joint tiltably relative to the tool ring by two degrees of freedom. Depending on the tilted position of the mandrel support, a distribution of a width of the extrusion annulus can be adjusted. A centering device serves to set the tilted position of the mandrel support. The result is an extrusion die, which ensures manageable adjustment of a wall width of a hollow profile in mass production.

### TECHNICAL FIELD

The disclosure relates to a die for a hollow profile extruder, in particular, a tube extruder. The disclosure further relates to a die assembly with such a die, an extruder with such a die or die assembly, and to an extrusion line having such an extruder.

### BACKGROUND

An extruder for silicone material is disclosed in WO 2005/039847 A1. Extrusion dies in form of a tubing nozzle are disclosed in DE 10 2014 103 521 B3, EP 0 075 809 A1, EP 2 768 653 B1, and DE 197 24 692 A1.

It is an object of the present invention to improve a die for a hollow profile extruder, in particular for a tube extruder, such that a defined a wall thickness of a tube wall can be guaranteed in a manageable way during mass production.

### SUMMARY

An improved die for extruding hollow profiles, in particular, tubes, through an extrusion annulus is presented. The die allows adjustment of a circumferential distribution of a width of the extrusion annulus. The extrusion annulus is defined by a mandrel which is disposed within a die ring. The width of the extrusion annulus corresponds to a circumferential distribution of a thickness of the hollow profile to be extruded. The hollow profile may, in particular, be a tube. The thickness adjustment is achieved by adjusting a tilt of the mandrel relative to the die ring. A relative position of an extruded hollow profile or tube jacket wall, which is defined by an outer boundary of the extrusion annulus, i.e. by a position of the die ring, remains independent of the mandrel tilt position. Therefore, to adjust the circumferential distribution of the width of the extrusion annulus no displacement of the die ring relative to the housing is required. This results in a defined position of a jacket wall of the hollow profile or tube to be extruded immediately behind the die, which is advantageous for subsequent guidance or capturing of the tube to be extruded, in particular, adjacent to the die. As a result, for example, a sensory capturing of parameters of the hollow profile, in particular of parameters of the tube, can be simplified and/or improved. The extrusion annulus may follow a heart-shaped curve. A material flow path for the material to be extruded, which opens into the extrusion annulus, can be formed in a distributor body which is mounted in the die housing of the extrusion die. At least one cooling channel for cooling the die can be arranged in the die housing. A tilt joint, by which the mandrel support can be tilted relative to the die ring, may have hardened surfaces. The tilt joint may have powder metallurgically treated surfaces. At least one of the surfaces of the tilt joint may have a slide coating. The mandrel and/or the die ring can be designed as replacement parts. To equip the die, a set may include with different pairings of a respective mandrel and a respective die ring or a set with a plurality of mandrels/die rings, which are adapted to a die ring/mandrel.

A holder of the die ring from the axial adjustment housing body against the direction of the force of the extrusion pressure makes it possible, for example, to adjust, by adjusting an axial position of the axial adjustment housing body, an axial position of the die ring to the mandrel. Such axial position adjustment allows setting a circumferentially averaged width of the extrusion annulus. The axial adjustment housing body can be designed as a centering nut. The axial adjustment housing body may be mounted in a receptacle which in turn is mounted to the housing.

The tilt joint may be arranged on a side of the mandrel support which faces the mandrel, and the centering device may be arranged at an opposite free end of the mandrel support which faces away from the mandrel. This arrangement utilizes a lever effect of the mandrel support for tilting the mandrel. A distance of the centering device to the tilt joint can be greater than a distance between the tilt joint and a nozzle outlet of the extrusion annulus. For example, this distance may be more than 1.1 times, more than 1.2 times, more than 1.25 times, more than 1.5 times, more than 2 times, more than that 3 times, or even more than 5 times the distance between the tilt joint and the nozzle opening.

The centering device may include a plurality of centering actuators which are supported at the die housing and extending radially to the mandrel support. The centering actuators may have free ends which abut the mandrel support. Such centering actuators have proven themselves for setting a tilting position of the mandrel. The centering actuators can be designed as centering screws. The centering device can be carried by a centering ring, which in turn is mounted on the die housing. The centering ring can be mounted on the distributor body. A housing-side internal thread, which is designed to be complementary to the respective centering actuator, may be part of a centering sleeve fixedly connected to the die housing.

A ball joint has proven itself as a tilt joint for infinitely variable (stepless) setting of the tilt position of the mandrel relative to the die ring. The ball joint can be designed with a predetermined tolerance between the joint parts, i.e. a joint head or a dome-shaped part and a joint socket or a socket part.

A dome-shaped part of the ball joint may be integrally formed on the mandrel support. This configuration has proven itself, particularly for stability reasons. A socket part of the ball joint may be arranged on the housing side. The socket part can be embodied in a distributor body mounted in the housing and/or in a centering ring of the centering device or else directly in the die housing.

The die ring may be floatingly supported by the axial adjustment housing body. Such a holder of the die ring avoids undesirable load peaks in the transmission of the extrusion pressure from the die ring onto the axial adjustment housing body.

A die assembly may include the improved die, at least one sensor for measuring a wall thickness of a tube extruded with the die, and a control device which is in signal communication with the sensor and with at least one actuator of the centering device. The advantages of such a die assembly correspond to those which have already been explained above with reference to the die. Due to the control/regulating device, the die assembly makes it possible to control or regulate keeping certain parameters of the tube to be extruded within predetermined tolerance limits. In particular, a closed-loop control can be implemented. The at least one actuator of the centering device can be implemented in the form of one or more motor-driven centering screws. The at least one actuator can be designed as a stepper motor. The at least one actuator can interact with a planetary gear. Alternatively or in addition to the signal connection with at least one actuator of the centering device, the control device can also cooperate with an actuator which acts on the axial adjustment housing body for adjustment of the same. This applies in particular if the axial adjustment housing body is designed as centering nut. The actuator can then affect rotation of the centering nut. Also, in this case, the actuator can be designed as a stepper motor and can act on the centering nut via a planetary gear.

The sensor may be a sensor for measuring a wall thickness of the tube extruded with the die. The sensor can be designed as a radiometric sensor, for example as an X-ray sensor. Alternatively or additionally, the sensor may be designed as a microwave or as an ultrasonic sensor. The control/regulating device can additionally detect a plurality of further input variables of the extruder and/or the extrusion line and pass control signals to drive units or actuators of the extruder and the extrusion line for controlling and/or regulating corresponding parameters. In particular, the maintenance of a constant feed pressure has proven particularly advantageous for the extrusion result. The input variables may be an actual feed temperature of the extrusion material or else a discharge pressure of the extruded mass in the region of the die or else a discharge temperature.

The improved die may be used in an extruder, which together with a feeder forms an extrusion line. The feeder of the extrusion line may be a feeder with a feed screw and a hopper. Alternatively, the feeder according to this further aspect may also be constructed differently.

The extruder may be a silicone extruder and/or an extruder for a thermoplastic material or for a polyolefin material. An extruded hollow profile or an extruded tube can be used in particular in medical technology.

The following detailed description is merely exemplary in nature and is not intended to limit the invention or the application and uses of the invention. Furthermore, there is no intention to be bound by any theory presented in the preceding background or the following detailed description of the invention.

### BRIEF DESCRIPTION OF THE DRAWINGS

FIG. 1 is a perspective view of an extrusion line with an extruder and a feeder in a feed position for feeding the extruder with a mass to be extruded.

FIG. 2 schematically shows a section through a die of the extruder of the extrusion line according to FIG. 1.

FIG. 3 shows a signal processing scheme in a controlled operation of the extrusion line.

### DETAILED DESCRIPTION

An extrusion line 1 includes an extruder 2 and a feeder 3 for feeding the extruder 2 with mass to be extruded. The mass to be extruded may be silicone. The mass to be extruded may also be another material, for example, a thermoplastic. The extruder 2 is designed as a hollow profile extruder and in the illustrated embodiment as a tube extruder. The feeder 3 has a feeder box 4, which opens on the bottom side in a hopper 5. The latter in turn opens into a bottom-side feed opening 6. The mass feed opening 6 is connected via a feed channel 7 in fluid communication with a feed zone of the extruder 2.

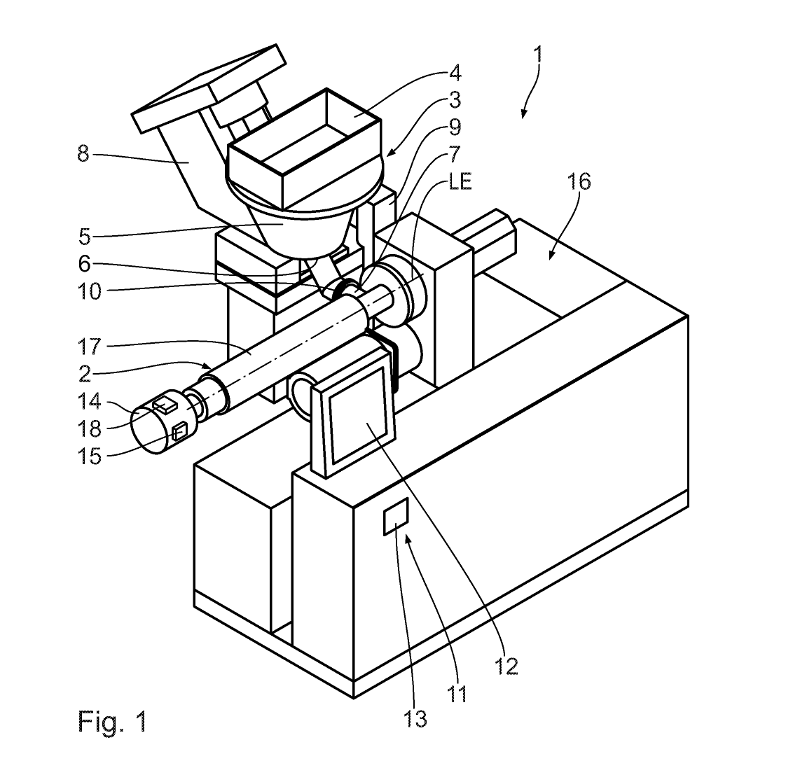

FIG. 1 shows an embodiment of the feeder with upright hopper 5. An alternative embodiment, not shown, has a slanted feed hopper 5.

The extruder 2 can be designed as a single-screw or as a twin-screw extruder.

Part of the feeder 3 is a feed screw, which is not shown. The latter is mounted axially and radially on a frame housing 8 of the extrusion line 1.

The feeding hopper 5 is designed to be rotatably drivable. Near the feed opening 6, the feed hopper 5 is again mounted axially and radially relative to the frame housing 8.

The two rotary drives for the feed screw, on the one hand, and the hopper 5, on the other hand, are executed independently. In an alternative embodiment of the extrusion line 1, a common drive for the feed screw on the one hand and the hopper 5, on the other hand, may be present. In that case, a predetermined speed ratio between a feed screw speed, on the one hand, and a hopper speed, on the other hand, can be set via a transmission or reduction gear of such a common drive. The rotary drives or the common drive for the feed screw and the hopper 5 can be designed as a synchronous motor.

The feeder 3 is cooled with cooling water, which may be circulated.

FIG. 1 shows the feeder 3 in a feed position, i.e. in an operating position for feeding the mass to be extruded via the feeder box 4, the hopper 5, the feed opening 6, and the feed channel 7 to the feed zone of the extruder 2.

The feeder 3 can be displaced into a cleaning or maintenance position which is swung out about a vertical pivot axis relative to the feed position of FIG. 1 and displaced linearly downwards along this pivot axis. This swung-out cleaning or maintenance position is not shown in the drawing. Both the pivoting and the displacement movement are guided in a displacement frame section 9 of the frame housing 8.

To prepare the swinging out of the feeder 3 into the cleaning or maintenance position, a flange connection 10 is released between two sections of the feed channel 7.

The extrusion line 1 has a central controller 11 with an operating terminal 12. The controller 11 is in signal communication with the two rotary drives of the feed screw and the hopper 5.

In a transition region between the feeder 3 and the extruder 2, that is in the region of the feed channel 7, a feed-pressure sensor BDS (cf. 3) is arranged. The latter is used to measure an actual feed pressure of the mass to be extruded. The pressure sensor BDS is arranged so that a sensor signal of the pressure sensor BDS for regulating a pressure of the mass to be extruded can be generated directly in front of the feed zone of the extruder 2. For this purpose, the pressure sensor BDS can be arranged directly adjacent to the intake zone.

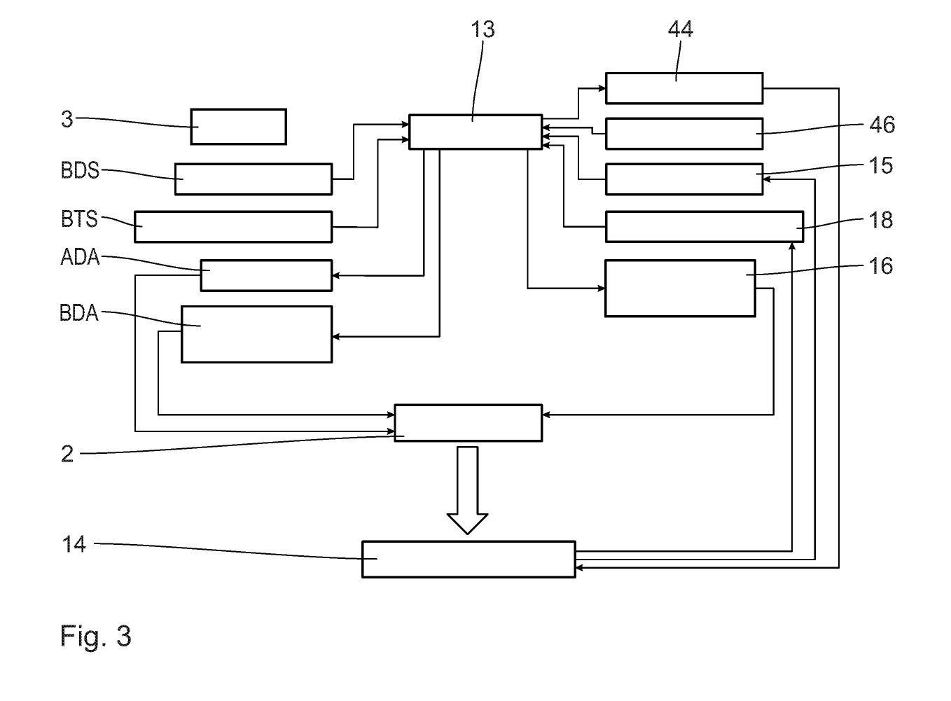

Part of the controller 11 is a control unit 13 schematically indicated in FIG. 1 (see also the signal processing scheme of FIG. 3). The control unit 13 is in signal communication with the feed pressure sensor BDS and the feed drive device, that is, the feed rotary drive BDA and/or the hopper rotary drive ADA. The control unit 13 is used to adjust a desired feed pressure and to forward an actuating signal to the feed drive unit BDA as a function of a determined difference between the desired feed pressure and the actual feed pressure.

In the feed channel 7 is further arranged a feed temperature sensor BTS for measuring an actual feed temperature of the mass to be extruded. The feed temperature sensor BTS is in signal communication with the control unit 13.

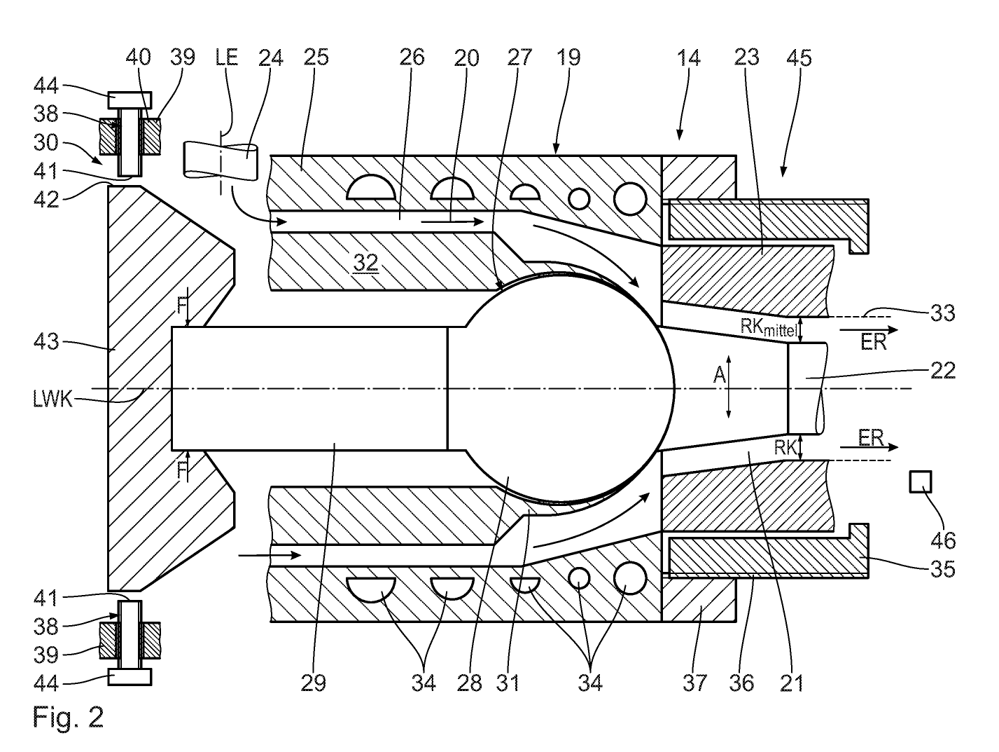

Furthermore, the extrusion line 1 has a die pressure sensor 15 in a die 14 of the extruder 2, which is shown in more detail in FIG. 2 and arranged in the region of a discharge zone of the extruder 2. The latter serves to measure an actual discharge pressure of the extruded mass. The control unit 13 is in signal communication with the die pressure sensor 15 and an extruder drive unit 16. The extruder drive unit 16 serves to drive at least one extruder screw, which runs in a housing cylinder 17 of the extruder 2. The control unit 13 also serves to set a desired extrusion pressure of the mass to be extruded and for forwarding a corresponding control signal to the extruder drive unit 16 as a function of a determined difference between the target extrusion pressure and the actual extrusion pressure.

The extrusion line 1 furthermore has a discharge temperature sensor 18, which is likewise arranged in the die 14 of the extruder 2. The discharge temperature sensor 18 serves to measure an actual discharge temperature of the mass to be extruded. The discharge temperature sensor 18 is in signal communication with the control unit 13.

FIG. 2 shows details of the die 14 in an axial longitudinal section.

The die 14 has a die housing 19, in which a material or mass flow path 20 is predetermined, the outlet nozzle side of which opens into an extrusion annulus 21.

The extrusion annulus 21 is defined on the inside by a mandrel 22 and is defined to the outside by a die ring 23. Towards an outlet nozzle of the die 14, the mandrel 22 and the die ring 23 are not shown completely but broken off. Compared to a longitudinal axis LE of the extruder 2 (see FIG. 1) a longitudinal axis LWK of the die 14 may be in alignment, arranged in parallel, or, as in the described embodiment, arranged perpendicular thereto. In the embodiment of FIG. 2, the longitudinal axis LWK of the die 14 thus extends radially to the longitudinal axis LE of the extruder 2. A material inlet 24 from the extruder 2 thus extends through a jacket wall 25 of the die housing 19, as schematically shown in FIG. 2.

This material inlet 24 forms an inlet channel which is in fluid communication with the extrusion annulus 21 via a distribution channel 26 and the material flow path 20.

The mandrel (22) is held and supported by a housing-side mandrel support 27. The mandrel support 27 has a dome-shaped mandrel joint portion 28 and a tilt rod portion 29. At a free end of the tilt rod portion 29 of the mandrel support 27, which faces away from a mandrel side of the mandrel support 27 with the mandrel 22, a centering device 30 is arranged, which will be explained in more detail in the following.

The mandrel support 27 is mounted by a tilt joint tiltable in two degrees of freedom relative to the die ring 23. The tilt joint is formed on the one hand by the mandrel joint portion 28 as a dome-shaped part and a complementary thereto designed socket portion 31 of a distributor body 32, as a socket part. The distributor body 32 is mounted fixed to the housing in the die housing 19.

The tilt joint 28, 31 is designed as a ball joint. Between the two joint parts of the ball joint 28, 31, i.e. between the mandrel-joint portion 28 and the distributor socket portion 31, a predetermined component clearance, for example in the range between 50 μm and 200 μm, may be provided. The dome-shaped part of the ball joint 28, 31, thus the mandrel joint portion, may be formed as one part on the tilt rod portion 29 of the mandrel support 27. The tilt joint 28, 31 may have hardened surfaces on the mandrel joint portion 28 and/or the distributor socket portion 31. These may be powder metallurgically treated surfaces. The surfaces 28, 31 of the tilt joint may have a slide coating.

The tiltability of the mandrel support 27 relative to the die ring 23 via the tilt joint 28, 31 is such that, depending on the tilt position of the mandrel support 27, a circumferential distribution of a width RK of the extrusion annulus 21 between a nozzle-side portion of the mandrel 22 and the die ring 23 can be adjusted. Depending on the tilting of the mandrel 22 via the tilting joint 28, 31 an adjustable distribution of the width RK of the extrusion annulus 21 in the circumferential direction about the longitudinal axis LWK of the die 14 results. This enables a circumferential homogenization of a tube wall thickness of a tube extruded with the extruder 2. A relative position of a tube jacket wall 33, which is shown in dotted line in FIG. 2, remains independent of a tilted position of the tilting joint 28, 31. To adjust the circumferential distribution of the width RK of the extrusion annulus 21, a displacement of the die ring 23 is not required.

The material flow path 20 between the material inlet 24 and the extrusion annulus 21 can follow a heart-shaped curve. A description of this can be found by the person skilled in the art, for example, in the textbook “Handbuch Urformen—Edition Handbuch der Fertigungstechnik” (second edition, 2003, Carl Hanser Verlag, publisher Bührig-Polaczek et al.).

In the die housing 19, a plurality of cooling channels 34 are provided, through which a cooling fluid for cooling the die 14 can flow. The cooling fluid can generally be a temperature control fluid for controlling the temperature of the die 14, i.e. for maintaining a predetermined temperature of the die 14.

The mandrel 22 and/or the die ring 23 can be designed as replacement parts. In particular, different pairings of one type each of the mandrel 22 and one type of die ring 23 can be arranged. The delivery content of the die 14 may accordingly include a set of several such pairings of mandrel/die ring.

The mandrel 22 may be releasably connected to the mandrel support 27, for example via a screw connection. The die ring 23 may be held against an extrusion direction ER by an axial adjustment housing body 35. The latter can be screwed by a thread 36 to an adjusting portion 37 of the die housing 19. The axial adjustment housing body 35 may be designed as a centering nut. The adjusting section 37 forms a receptacle for the axial adjustment housing body 35. By adjusting an axial position of the axial adjustment housing body 35 relative to the die housing 19 an axial position of the die ring 23 to the mandrel 22 can be adjusted.

The die ring 23 is floatingly received in the axial adjustment housing body 35.

This adjustment of the axial position, in conjunction with a conical shaping of the mandrel 22 and/or the die ring 23 in the region of the extrusion annulus 21, allows the adjustment of an average circumferential width RK_{Mittel} of the extrusion annulus 21. The axial position of the die ring 23 relative to the mandrel 22, which can be set by the axial adjustment housing body 35, thus determines a wall thickness of the tube to be extruded.

The centering device 30 has a plurality of centering actuators in the form of centering screws 38, of which two centering screws 38 are shown schematically in FIG. 2. The centering screws 38 extend radially to the longitudinal axis LWK of the die 14 and thus in a good approximation also radially to the longitudinal axis of the mandrel support 27. The centering screws 38 are mounted on the die housing 19 in a manner not shown. For this purpose, the centering screws 38 may be screwed into annular portions 39 of an otherwise not shown centering ring, which in turn is mounted on the die housing 19 and/or on the distributor body 32. An internal thread of the annular portion 39 may also be part of a centering sleeve 40 which is separate from and fixedly connected to the die housing 19, which is indicated in FIG. 2.

Free ends 41 of the centering screws 38 abut against a peripheral wall 42 of a centering head 43 of the mandrel support 27. The centering head 43 is fixedly connected to the tilt rod portion 29 of the mandrel support 27 and may be an integral part of the tilt rod portion 29. Through a depth of the centering screws 38 in the respective centering sleeves 40, the respective tilt position, i.e. the position of the longitudinal axis of the mandrel support 27 to the longitudinal axis of the entire die 14, can be adjusted. For example, three or even more centering screws 38 of the type of centering screws 38 shown in FIG. 2 may be arranged, in particular circumferentially evenly distributed around the longitudinal axis LWK of the die 14, so that in particular an infinitely variable adjustment of a tilted position of the mandrel support 27 in the two tilting degrees of freedom is possible.

The centering screws 38 can be driven in a motorized way by corresponding respectively associated rotary drives 44.

Additionally, at least one sensor 46 for measuring a wall thickness of the extruded tube may belong to a die assembly 45, of which the die 14 is a part. The wall thickness sensor 46 can be designed as a radiometric sensor, for example as an X-ray sensor. Both the rotary drives 44, which then represent actuators of the centering device 30, and the at least one wall thickness sensor 46 are in signal communication with the controller 11 and the control unit 13 (see also FIG. 3).

An adjustment of the average width of the extrusion annulus 21 can be made infinitely variably with an accuracy in the range of 1/100 millimeter.

Instead of an X-ray sensor, a sensory detection via THz waves can also take place.

A wall thickness of a tube to be extruded can be set to a predetermined value with a tolerance that is less than 100 μm, which may be less than 50 μm, which may be less than 30 μm, which may be less than 20 μm and also may be less than 10 μm.

In variants of the extrusion line 1, it is also possible to use a plurality of feed pressure sensors and/or a plurality of feed temperature sensors and/or a plurality of die pressure sensors and/or a plurality of discharge temperature sensors. Various temperature sensors can be arranged in particular in different temperature zones of the extruder 2.

A temperature in the at least one temperature zone in the conveying path of the extrudate mass of the extrusion line 1 can be adjusted via a temperature control medium. For example, the hopper 5 and/or the feed channel 7 and/or the extruder 2 can be actively temperature controlled, in particular cooled, by a temperature control medium, for example with water, optionally in zones.

Another controlled variable, which can be kept constant by comparing a measured actual value with a predetermined desired value via the control unit 13, is a material throughput in the conveying path of the extrusion line 1. This throughput can be measured at different points of the entire conveying path between the feeder 3 and the die 14.

During extrusion with the extrusion line 1, the mass to be extruded is first introduced into the feeder 3. Subsequently, the mass to be extruded is conveyed through the feeder 3 and the extruder 2. The produced extrudate is then discharged in profile or tube form through the die 14 from the extruder 2. In a controlled operation of the extrusion line 1, a controlled conveying of the mass takes place through the feeder 3 and the extruder 2 using the control signals of the control unit 13. These control signals of the control unit 13 can act on the hopper rotary drive ADA and/or on the screw rotary actuator BDA and/or the extruder drive unit 16 and/or actuator components of the die 14, such as for example the actuators 44 of the centering device 30. Depending on the sensor measurements, for example, a rotational speed of the hopper 5, a rotational speed of the feed screw and/or a screw speed of the extruder 2 can be adjusted, respectively variables of adjustable components of the die 14, such as the circumferential distribution and/or the mean value of the width RK of the extrusion annulus 21, can be adjusted. Drives of the extrusion line 1, especially the rotary drives 10, 15, 44 and the extrusion drive 16, can be designed to be infinitely variable.

Instead of an embodiment of the centering device 30 with centering screws, a tilt position adjustment in the region of the centering head 43 can also be effected via linearly displaceable reciprocating pistons. Drives of the centering device can be designed as electric motors or hydraulic cylinders.

A cooling of the die 14 can be controlled or regulated and, in particular, depending on the material throughput, a Shore hardness of the material and depending on the respective design of the material flow path 20 on the one hand take place in the region of the distributor body 32 and on the other hand take place in the region of the nozzle-side outlet in the extrusion annulus.

While the present invention has been described with reference to exemplary embodiments, it will be readily apparent to those skilled in the art that the invention is not limited to the disclosed or illustrated embodiments but, on the contrary, is intended to cover numerous other modifications, substitutions, variations and broad equivalent arrangements that are included within the spirit and scope of the following claims.

What is claimed is:

1. A die for a hollow-section extruder (2), comprising:
a die housing (19);
an extrusion annulus (21) bounded inwardly by a mandrel (22) and bounded outwardly by a die ring (23);
a mandrel support (27) which holds the mandrel (22) on a side of the mandrel facing the die housing;
a tilt joint (28, 31) by which the mandrel support (27) is tiltably mounted within the die housing, allowing the mandrel support to tilt relative to the die ring (23) by two degrees of freedom, whereby, depending on a tilt position of the mandrel support (27), a circumferential distribution of a width of the extrusion annulus (21) can be adjusted;
a centering device (30) for adjusting the tilt position of the mandrel support (27); and
an axial adjustment housing body (35) which secures an axial position of the die ring (23) against a force direction of an extrusion pressure.

2. The die according to claim 1,
wherein the tilt joint (28, 31) is arranged on a side of the mandrel support (27) which faces the mandrel, and
wherein the centering device (30) is arranged at an opposite free end of the mandrel support (27) which faces away from the mandrel.

3. The die according to claim 1,
wherein the centering device (30) comprises a plurality of centering actuators (38) supported at the die housing and extending radially to the mandrel support (27), the centering actuators (38) having free ends (41) which abut the mandrel support (27).

4. The die according to claim 1,
wherein the tilt joint (28, 31) is a ball joint.

5. The die according to claim 4,
wherein a dome-shaped part (31) of the ball joint (28, 31) is integrally formed on the mandrel support (27).

6. The die according to claim 1,
wherein the die ring (23) is floatingly supported by the axial adjustment housing body (35).

7. A die assembly, comprising:
the die (14) according to claim 1;
at least one sensor (46) for measuring a wall thickness of a tube extruded with the die;
a control device which is in signal communication with the sensor (46); and with at least one actuator (44) of the centering device (30).

8. An extruder, comprising the die assembly according to claim 7.

9. An extrusion line, comprising:
the extruder according to claim 8; and
a feeder (3) for feeding the extruder (2) with material to be extruded.
